(19) United States
(12) Patent Application Publication
(10) Pub. No.: US 2008/0150930 A1
(43) Pub. Date: Jun. 26, 2008

(54) LIQUID CRYSTAL DISPLAY DEVICES AND METHODS THAT COMPENSATE FOR LOCATION-BASED SOURCE DRIVER POWER VOLTAGE VARIATIONS

(75) Inventors: Jang-jin Nam, Yongin-si (KR); Hee-young Seo, Suwon-si (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/762,266

(22) Filed: Jun. 13, 2007

(30) Foreign Application Priority Data
Dec. 26, 2006 (KR) 10-2006-00134173

(51) Int. Cl. G09G 5/00; G06F 3/038; G09G 3/38

(52) U.S. Cl. 345/212; 345/211

(57) ABSTRACT

A driving circuit for a liquid crystal display (LCD) includes a timing controller that divides a power voltage, which is supplied from a power source unit, into a plurality of gamma reference voltages. A regulator generates a second voltage from a first voltage by using the gamma reference voltages as internal reference voltages, where the first voltage is an input voltage and the second voltage is an output voltage. A source driver uses the second voltage as an internal bias voltage. Accordingly, it is possible to apply a relatively constant power/ground voltage to a source driver regardless of the location of the source driver in the LCD. Related LCD devices and operational methods are also described.

### CROSS-REFERENCE TO RELATED PATENT APPLICATION

This application claims the benefit under 35 USC §119 of Korean Patent Application No. 10-2006-00134173, filed on Dec. 26, 2006, the disclosure of which is hereby incorporated herein by reference in its entirety as if set forth fully herein.

### FIELD OF THE INVENTION

The present invention relates to liquid crystal displays (LCDs) and operating methods therefor, and more particularly, to circuits and methods for driving LCD panels.

### BACKGROUND OF THE INVENTION

Liquid crystal display (LCDs) devices have been widely applied to notebook computers, LCD televisions (TVs) and other display applications, since they are compact and can operate with low power. In particular, an active matrix type LCD that uses a thin film transistor (TFT) as a switching device is widely used for displaying moving pictures.

FIG. 1 is a schematic diagram illustrating a conventional LCD. Referring to FIG. 1, a conventional LCD includes an LCD panel 130 in which pixels are arranged in a matrix form; a source driver 110 that drives source lines SL1 through SLn of the LCD panel 130; a gate driver 120 that drives gate lines GL1 through GLn of the LCD panel 130; a timing controller 100 that controls the source driver 110 and the gate driver 120; a power source unit 140 that provides driving voltages for driving the source driver 110, the gate driver 120, and the timing controller 100; and a DC-to-DC converter 150 that generates a common voltage Vcom to be used by the LCD panel 130.

In more detail, the timing controller 100 receives RGB data, a vertical/horizontal synchronization signal, a clock signal, and a control signal from an LCD channel driving system (not shown), and provides the RGB data, the control signal, and a gamma reference voltage to the source driver 110 at a timing allowing the LCD panel 130 to reproduce an image. Here, the gamma reference voltage is used by the source driver 110 in order to transform digital data into analog data. Also, the timing controller 100 provides the control signal to the gate driver 120.

The gate driver 120 sequentially applies a gate voltage to the gate lines GL1 through GLn, in response to the control signal received from the timing controller 120. The source driver 110 sequentially applies the RGB data corresponding to individual vertical lines to the source lines SL1 through SLn, in response to the control signal. The source lines may also be referred to as data lines or channels.

FIG. 2 is a diagram illustrating in detail a structure of a single pixel of the pixels illustrated in FIG. 1. Referring to FIG. 2, a gate line GL and a source line SL intersect each other, for example at right angles. A gate electrode G of a TFT is connected to the gate line GL, and the source electrode S is connected to the source line SL. A pixel electrode P and a common electrode C that constitute a liquid crystal capacitor are sequentially provided from a drain electrode D, and the common voltage Vcom generated by the DC-to-DC converter 150 is applied to the common electrode C. Also, a liquid crystal layer is formed between the pixel electrode P and the common electrode C, and a storage capacitor Cst that reduces leakage current of the liquid crystal capacitor is connected to the drain electrode D.

The TFT is turned on or off by the gate voltage applied via the gate line GL. When the TFT is turned on, data received via the source line SL is applied to the pixel electrode P and the liquid crystal capacitor is charged with a voltage difference between the pixel electrode P and the common electrode C. Then, if the TFT is turned off, the applied data remains stored in the pixel electrode P. The transmissivity of the liquid crystal layer is determined by a difference between the electric potentials of the pixel electrode P and the common electrode C.

FIG. 3 is a schematic view illustrating the locations of source drivers of a conventional LCD. Referring to FIG. 3, source drivers SD1 through SD8 and an LCD panel 210 that are needed for an LCD may be formed on a glass substrate according to a chip-on-glass (COG) method. In general, a timing controller is formed on a printed circuit board (PCB), and the source drivers SD1 through SD8 are formed on lower (bottom) glass.

As described above, the timing controller provides RGB data, a control signal, and a gamma reference voltage to a plurality of source drivers SD1 through SD8 via a transmission line. A power source unit provides a power voltage to the source driver via a common power line that extends from external of the LCD panel to the plurality of source drivers. FIG. 3 illustrates eight source drivers but the total number of the source drivers may vary according to the size of the LCD panel 210.

If the COG and/or other method is employed, a resistance value may increase proportional to the length of a power line from a section of the common power line that extends external of the LCD panel, due to the difference between the resistivities of metal and glass. Accordingly, different power/ground voltages are respectively applied to the source drivers SD1 through SD8 that are located at different locations from a liquid crystal channel, thereby forming an offset between a rise time and a fall time of a signal output from each source driver.

FIG. 4 is a diagram illustrating a change in a power voltage and a ground voltage according to the locations of source drivers. Referring to FIG. 4, a power voltage VDD and a ground voltage VSS applied to a fourth source driver SD4 located at an end of the LCD panel, may be respectively lower and greater than those applied to a first source driver SD1 located at the center of LCD panel.

A change in the power voltage VDD and the ground voltage VSS may cause a slew offset, that may cause the LCD panel to be driven later than a desired point of time and/or an afterimage to occur on a screen.

FIG. 5 is a graph illustrating a variation in a slew rate versus a power voltage/ground voltage.

A slew rate represents how fast the voltage of an output signal changes, and is defined by the change of voltage over time. The slew rate may be an important factor that determines the characteristics of a driver. In particular, if the slew rate is too high, noise may increase, and if the slew rate is too low, jitter may increase. Accordingly, the slew rate should be appropriately adjusted.

As used herein, slew or slew rate indicate the length of time required to reach 90% of a high level when an output signal transmits from a low level to a high level.

FIG. 5 illustrates an output signal of an output buffer included in a source driver. The x-axis of the graph denotes a drop in a power voltage VDD/ground voltage VSS, and the y-axis denotes a variation in a slew according to the voltage drop. If the power voltage VDD or the ground voltage VSS does not drop, the slew is 1.15 μs. If a drop in the power voltage VDD or the ground voltage VSS is 1.5V, the slew is 1.7 μs. That is, the voltage drop of 1.5V causes a slew-gap of 0.55 μs. The slew-gap may cause output signals to be respectively output from source drivers at different times, which may degrade the image quality when driving an LCD.

### SUMMARY OF THE INVENTION

Some embodiments of the present invention provide an LCD that includes an LCD panel and a plurality of source drivers that are distributed at different locations on the LCD panel and are supplied with a power voltage (e.g., VDD and/or VSS) by a common power line that extends from external of the LCD panel to the plurality of source drivers. A compensating system and/or method is configured to provide different bias voltages to at least two of the source drivers based on their different locations on the LCD panel, so as to at least partially compensate for differences in the power voltage that is supplied to the source drivers by the common power line as a result of their different locations on the LCD panel. In some embodiments, the compensating system/method is configured to increase the bias voltage that is applied to a given source driver proportional to its distance from a section of the common power line that extends external of the LCD panel. Accordingly, some embodiments of the present invention can provide an LCD in which a constant power voltage/ground voltage may be applied regardless of the location of a source driver included in the LCD so as to stabilize an output of the source driver, and circuits and methods of driving the LCD.

According to other embodiments of the present invention, there is provided a liquid crystal display (LCD) which has an LCD panel and a driving circuit that drives the LCD panel. The driving circuit comprises a timing controller that is configured to divide a power voltage, which is supplied from a power source unit, into a plurality of gamma reference voltages; a regulator that is configured to generate a second voltage from a first voltage by using the gamma reference voltages as internal reference voltages, where the first voltage is an input voltage and the second voltage is an output voltage; and a source driver that is configured to use the second voltage as an internal bias voltage.

The second voltage may be adjusted according to a location of the source driver on the LCD panel.

If the first voltage is a power voltage, the second voltage may be increased proportional to the distance between the source driver and a center of the LCD panel. If the first voltage is a ground voltage, the second voltage may be decreased proportional to the distance between the source driver and the center of the LCD panel.

The second voltage may be adjusted by changing a resistance value of at least one of the resistors included in the regulator.

The gamma reference voltages may be categorized into a plurality of groups, and the regulator may use the gamma reference voltages belonging to one of the groups as the internal reference voltages.

The regulator may use as the internal reference voltages a highest gamma reference voltage and a lowest gamma reference voltage which belong to the group of the gamma reference voltages.

The LCD may further comprise a gamma buffer that is configured to amplify the gamma reference voltages received from the timing controller, and to output the amplified voltages to the regulator.

At least one of the gamma reference voltages may be applied to a first input terminal of a comparing amplifier included in the regulator, and at least one of the remaining gamma reference voltages may be applied to a supply terminal or a ground terminal of the regulator.

According to other embodiments of the present invention, there are provided methods of driving an LCD (liquid crystal display) by stabilizing an output of a source driver in the LCD. These methods can comprise dividing a power voltage, which is supplied from a power source unit, into a plurality of gamma reference voltages; generating a second voltage from a first voltage by using the gamma reference voltages as internal reference voltages of a regulator, where the first voltage is an input voltage and the second voltage is an output voltage; and using the second voltage as an internal bias voltage of a source driver.

### BRIEF DESCRIPTION OF THE DRAWINGS

The above and other aspects and advantages of the present invention will become more apparent by describing in detail embodiments thereof with reference to the attached drawings in which:

FIG. 1 is a block diagram illustrating a conventional liquid crystal display (LCD);

FIG. 2 illustrates in detail a structure of a pixel illustrated in FIG. 1;

FIG. 3 is a cross-sectional view illustrating locations of source drivers of a conventional LCD;

FIG. 4 is a diagram illustrating a change in a power voltage and a ground voltage according to the locations of source drivers;

FIG. 5 is a graph illustrating a variation in a slew rate versus a power voltage or a ground voltage;

FIG. 6 is a schematic block diagram of an LCD according to some embodiments of the present invention;

FIG. 7 is a diagram illustrating construction of a gamma resistor illustrated in FIG. 6 according to some embodiments of the present invention;

FIG. 8 is a circuit diagram illustrating in greater detail an LCD according to some embodiments of the present invention;

FIG. 9 is a flowchart illustrating operations that can be used to improve image quality according to some embodiments of the present invention; and

FIG. 10 is a graph illustrating the potential effect of improving image quality according to some embodiments of the present invention.

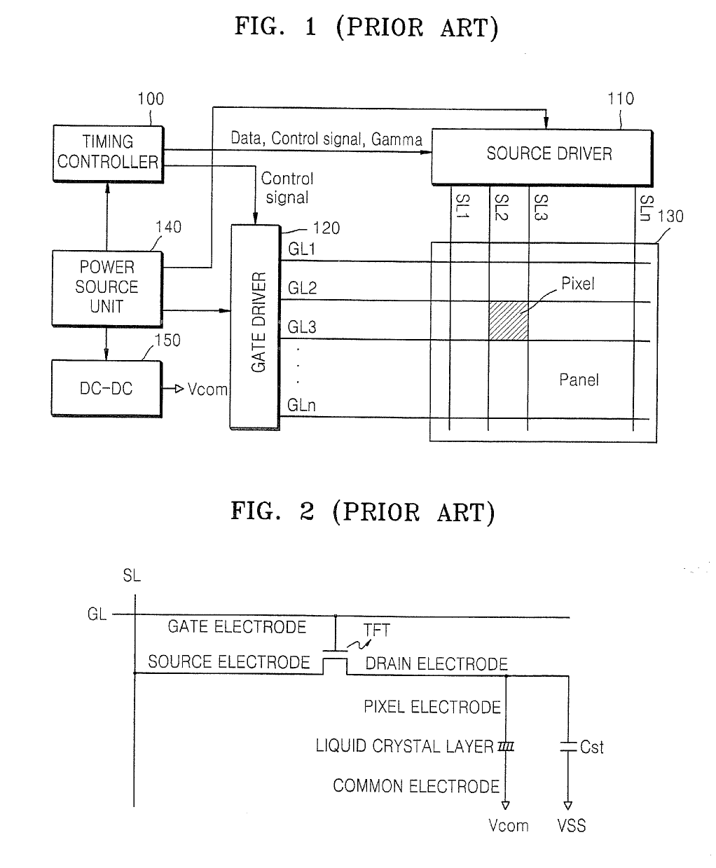

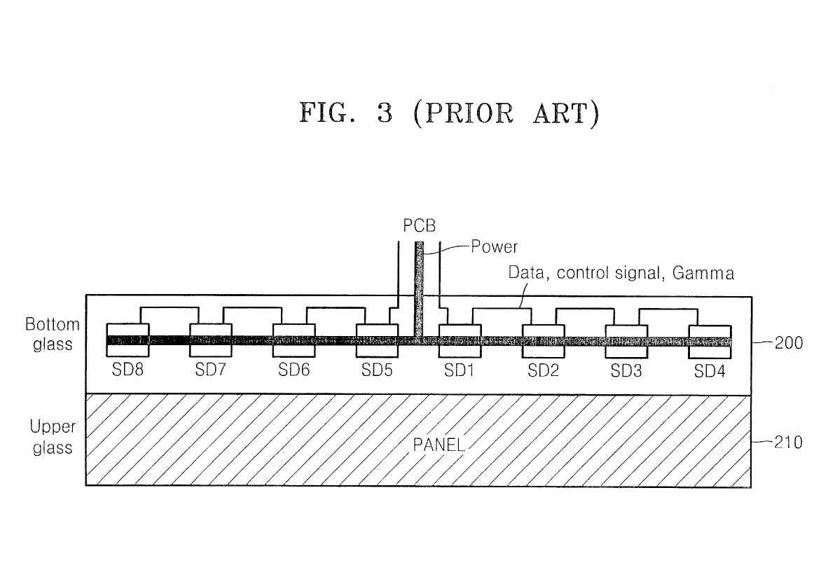

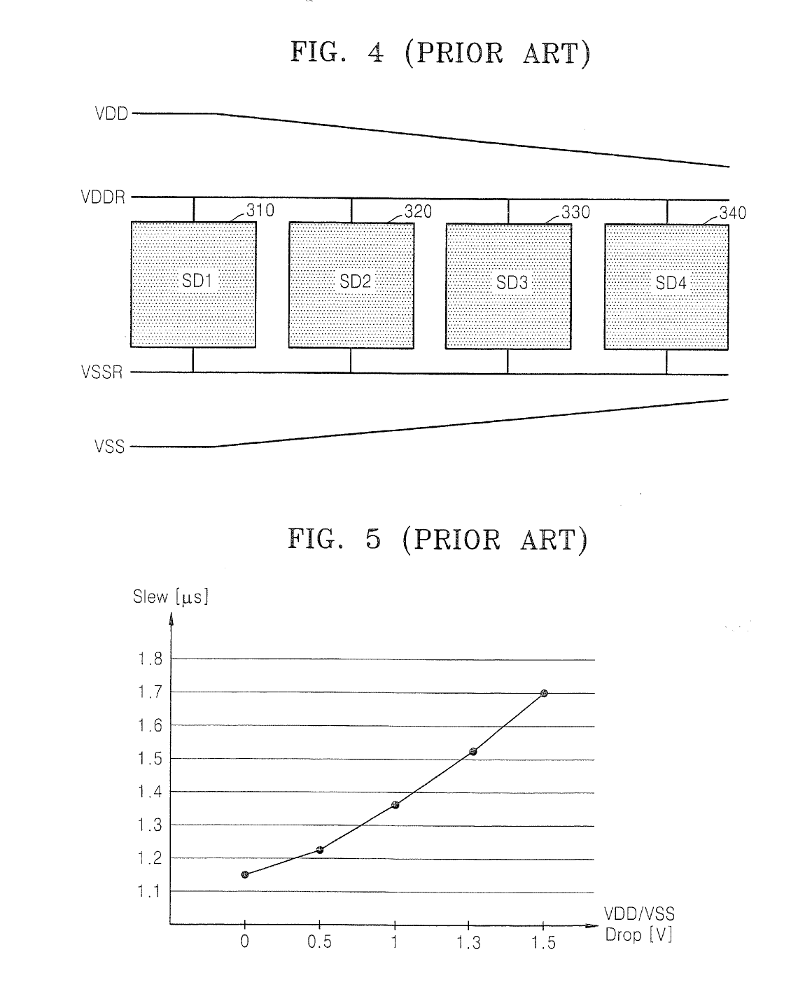

### DETAILED DESCRIPTION OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof. In contrast, the term “consisting of” when used in this specification, specifies the stated features, integers, steps, operations, elements, and/or components, and precludes additional features, integers, steps, operations, elements and/or components.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “lateral” or “vertical” may be used herein to describe a relationship of one element, layer or region to another element, layer or region as illustrated in the figures. It will be understood that these terms are intended to encompass different orientations of the device in addition to the orientation depicted in the figures.

Embodiments of the invention are described herein with reference to cross-section illustrations that are schematic illustrations of idealized embodiments (and intermediate structures) of the invention. The thickness of layers and regions in the drawings may be exaggerated for clarity. Additionally, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a discrete change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

The present invention is described below with reference to block diagrams and/or flowchart illustrations of methods and/or apparatus (systems) according to embodiments of the invention. It is understood that a block of the block diagrams and/or flowchart illustrations, and combinations of blocks in the block diagrams and/or flowchart illustrations, can embody apparatus/systems (structure), means (function) and/or steps (methods) for implementing the functions/acts specified in the block diagrams and/or flowchart block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Some embodiments of the invention can provide LCDs and driving circuits and methods that can reduce or eliminate degradation of the image quality due to a slew offset between signals output from source drivers of the LCD by applying a constant power voltage/ground voltage to the source drivers regardless of the locations of the source drivers in the LCD.

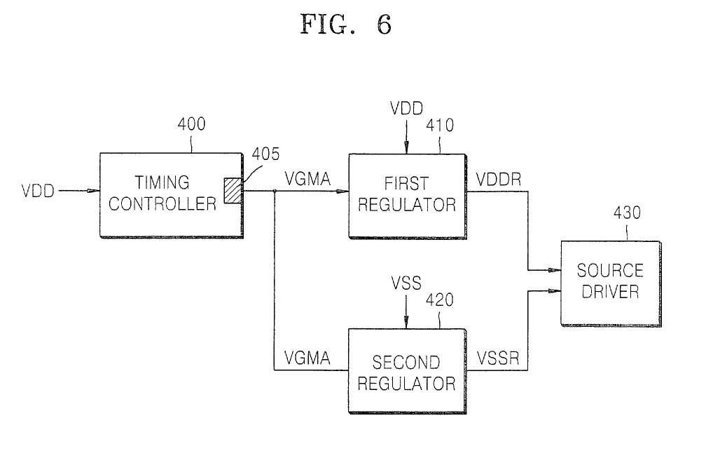

FIG. 6 is a schematic block diagram of a liquid crystal display (LCD) according to some embodiments of the present invention. Referring to FIG. 6, the LCD includes a timing controller 400, a first regulator 410, a second regulator 420, and a source driver 430. Also, a gamma resistor 405 is included in the timing controller 400. The gamma resistor 405 may be separate from the timing controller 400. Also, the first regulator 410 and/or the second regulator 420 may be included in the source driver 430.

The timing controller 400 receives a first power voltage VDD from a power source unit (not shown) and generates a gamma reference voltage VGMA from the first power voltage VDD. In detail, the gamma resistor 405 in the timing controller 400 generates the gamma reference voltage VGMA. The gamma reference voltage VGMA is a reference voltage based on which a digital-to-analog converter (DAC) included in the source driver 430 generates analog data from digital data. Also, as described above, the timing controller 400 generates a control signal for controlling a plurality of drivers, such as a gate/source driver.

The gamma reference voltage VGMA generated by the timing controller 400 is applied to the first and second regulators 410 and 420. The first regulator 410 generates a first output voltage VDDR from the first input voltage VDD by using the applied gamma reference voltage VGMA as an internal reference voltage. The second regulator 420 generates a second output voltage VSSR from a second input voltage VSS by the applied reference voltage VGMA as an internal reference voltage.

The source driver 430 receives the first voltage VDDR from the first regulator 410 and the second output voltage VSSR from the second regulator 420, and uses the first output voltage VDDR and the second output voltage VSSR as internal bias voltages. For example, the first output voltage VDDR and the second output voltage VSSR may be used as bias voltages of an output buffer (not shown) included in the source driver 430.

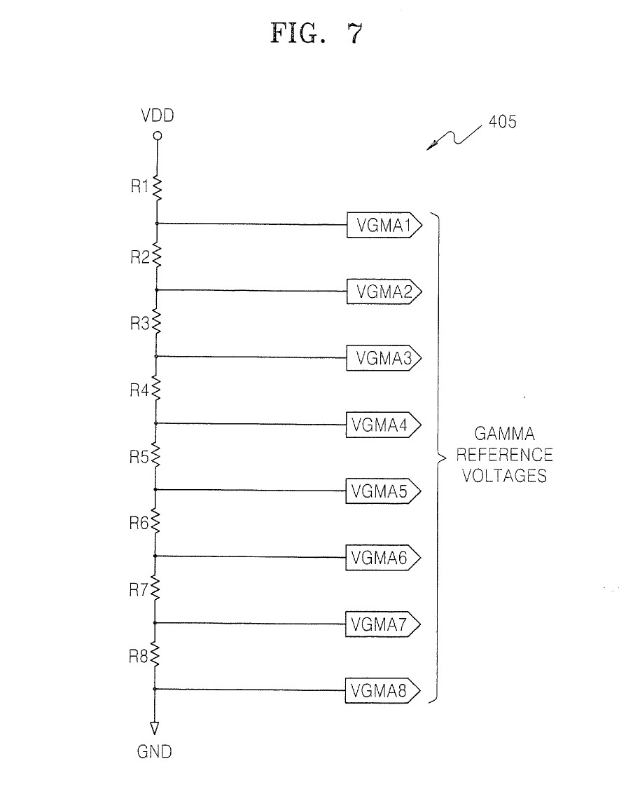

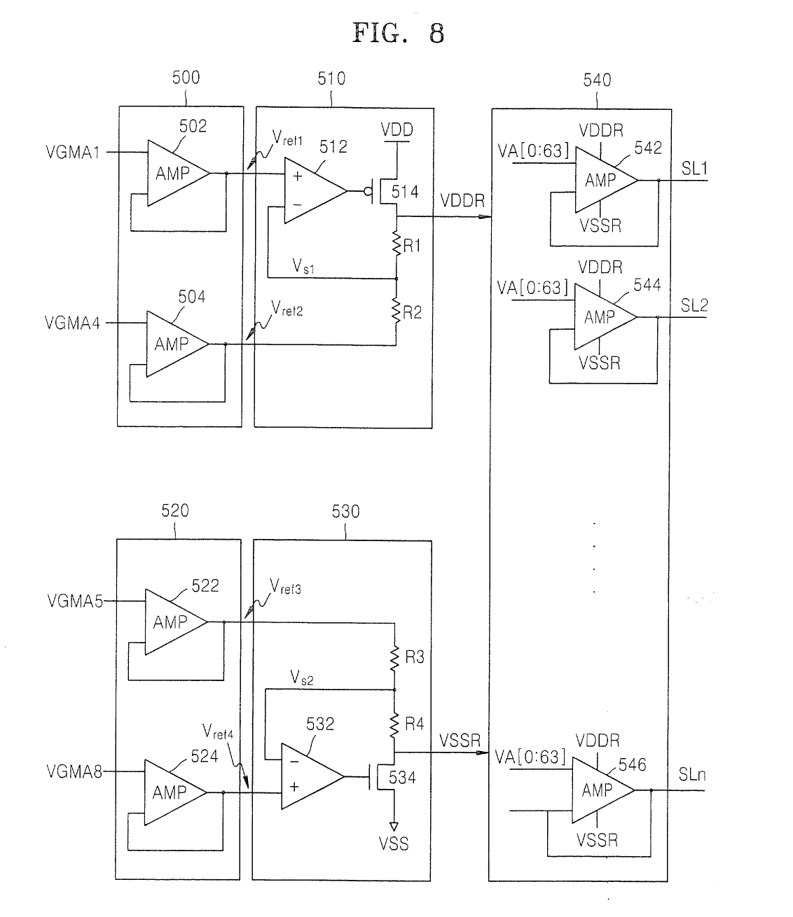

FIG. 7 is a diagram illustrating a construction of the gamma resistor 405 illustrated in FIG. 6 according to some embodiments of the present invention.

According to these embodiments, the gamma resistor 405 comprises a plurality of resistors R1 through R8 connected end to end in series between a power voltage source VDD and a ground voltage source GND. The gamma resistor 405 may be included in the timing controller 400 as described above and/or be included in a separate gamma reference voltage generator (not shown).

Referring to FIG. 7, the gamma resistor 405 divides a power voltage VDD into a plurality of gamma reference voltages VGMA1 through VGMA8 by using the plurality of resistors R1 through R8. FIG. 7 illustrates that eight gamma reference voltages are generated but four, twelve, sixteen or other numbers of gamma reference voltages may be generated as desired.

According to some embodiments of the present invention, a relatively constant power voltage and/or ground voltage, that are maintained at relatively constant levels regardless of the length of a power line, are respectively generated from a power voltage and a ground voltage, which may drop depending on the length of the power line. The relatively constant power/ground voltages may be generated using gamma reference voltages as internal reference voltages for regulators, the output of the regulators then being applied to all source drivers without causing a DC drop.

FIG. 8 is a circuit diagram illustrating in detail an LCD driving circuit according to some embodiments of the present invention.

Referring to FIG. 8, the LCD driving circuit includes a first gamma buffer 500, a first regulator 510, a second gamma buffer 520, a second regulator 530, and a source driver 540. Alternatively, the source driver 540 may be constructed to include the first and/or second gamma buffers 500 and 520 and/or the first and/or second regulators 510 and 530. Also, it is possible to construct the LCD circuit such that gamma reference voltages are applied directly to the first and/or second regulators 510 and 530 without the first and/or second gamma buffers 500 and 520.

The first gamma buffer 500 receives and amplifies gamma reference voltages VGMA1 and VGMA4, and outputs the amplified results. To this end, a first operational amplifier 502 and a second operational amplifier 504 are included. The second gamma buffer 520 receives and stably amplifies reference voltages VGMA5 and VGMA8, and outputs the amplified results. To this end, a third operational amplifier 522 and a fourth operational amplifier 524 are included.

Gamma reference voltages VGMA1 through VGMA8 generated by the timing controller 400 may be categorized into two groups according to a voltage level. For convenience of explanation, it is assumed that the gamma reference voltages VGMA1 through VGMA4 belonging to a first group are greater than the gamma reference voltages VGMA5 through VGMA8 belonging to a second group. Gamma reference voltages selected from among the gamma reference voltages VGMA1 through VGMA8 are respectively applied to the first gamma buffer 500 and the second gamma buffer 520.

The first gamma reference voltage VGMA1 (highest voltage) and the fourth gamma reference voltage VGMA4 (lowest voltage) belonging to the first group are applied to the first gamma buffer 500. The fifth gamma reference voltage VGMA5 (highest voltage) and the eighth gamma reference voltage VGMA8 (lowest voltage) belonging to the second group are applied to the second gamma buffer 520.

As described above, the gamma reference voltages may be categorized into two groups and the highest gamma reference voltages VGMA1 and VGAM5 and the lowest gamma reference voltages VGMA4 and VGMA8 of the first and second groups may be selectively applied so as to generate internal reference voltages that are to be used by the first regulator 510 and the second regulator 530.

According to the some embodiments, the first regulator 510 includes a first transistor 514, a first comparing amplifier 512, a first resistor R1, and a second resistor R2. An input voltage VDD is applied to the first and second resistors R1 and R2 via the first transistor 514. A voltage Vs1 distributed by the first and second resistors R1 and R2 is applied to the first comparing amplifier 512.

The first comparing amplifier 512 compares a first reference voltage Vref1 received from the first operational amplifier 502 with the distributed voltage Vs1, and controls the operation of the first transistor 514. A second reference voltage Vref2 output from the second operational amplifier 504 is applied to an end of the second resistor R2. The reason why the second reference voltage Vref2 rather than the ground voltage VSS is applied to one end of the second resistor R2, is that the ground voltage VSS may increase by an increase in a resistance S due to an increase in the total number of transmission lines.

A change in the output voltage VDDR of the first regulator 510 results in a change in the distributed voltage Vs1. Accordingly, when the distributed voltage Vs1 is greater than the first reference voltage Vref1, the first transistor 514 is turned off by a signal output from the first comparing amplifier 512, thus reducing the output voltage VDDR. When the distributed voltage Vs1 is smaller than the first reference voltage Vref1, the first transistor 514 is turned on thus increasing the output voltage VDDR. Therefore, even if the input voltage VDD is reduced, the output voltage VDDR may be maintained at a relatively constant level.

Similarly, according to some embodiments, the second regulator 530 includes a second transistor 534, a second comparing amplifier 532, a third resistor R3 and a fourth resistor R4. A voltage VSS is applied to the second transistor 534. A voltage Vs2 distributed by the resistors. R3 and R4 is applied to the second comparing amplifier 532.

The second comparing amplifier 532 controls the operation of the second transistor 534 by comparing a fourth reference voltage Vref4 received from the fourth operational amplifier 524 with the distributed voltage Vs2, and amplifying the result of the comparison. Also, a third reference voltage Vref3 output from the third operational amplifier 522 is applied to one end of the third resistor R3. The reason why the second reference voltage Vref2 rather than the power voltage VDD is applied to one end of the first resistor R1, is that the power voltage VDD may be reduced due to an increase in a resistance of the first resistor R1 due to an increase in the total number of transmission lines. As a result, even if the input voltage VSS increases, the output voltage VSSR may be maintained at a relatively constant level.

LCD circuits according to some embodiments of the present invention may have other potential advantages in that even if the same voltage VDD or VSS is applied, it is possible to adjust the output voltage VDDS or VSSR by changing the resistance values of the second resistor R2 in the first regulator 510 and/or the third resistor R3 in the second regulator 530. A reason why the output voltage VDDR or VSSR may be adjusted using resistance values as described above, is that the point in time when the power/ground voltage is applied may vary according to the location of the source driver 540 even if the same power/ground voltage is applied.

Thus, if the distance between the source driver 540 and the center of the LCD panel is large, the first output voltage VDDR may be increased by reducing the resistance value of the second resistor R2 and the second output voltage VSSR may be reduced by reducing the resistance value of the third resistor R3. In this way, it is possible to apply a substantially constant power/ground voltage to the source driver 540, irrespective of the location of the source driver 540 and/or the point in time when the power/ground voltage is applied. A variation in an extent of a voltage drop and the point in time when a voltage is applied versus the location of a source driver may be obtained through a test.

The source driver 540 includes a plurality of output buffers 542, 544, and 546. Although not shown, the source driver 540 includes a digital-to-analog converter (DAC), an output switch, and a charge-sharing switch. The DAC converts digital image signals into analog image signals, and outputs the analog image signals. Here, the analog image signals represent gradation-level voltages.

Each of the output buffers 542, 544, and 546 amplifies a corresponding gradation-level voltage VA[0:63] and transmits the amplified voltage to the output switch. The output buffers 542, 544, and 546 may be embodied as rail-to-rail operational amplifiers. The output switch supplies the amplified analog image signals to each source line (or channel) in response to the activated control signal. Then, the brightness of a pixel of an image that is to be displayed is determined by the gradation-level voltage applied via the corresponding source line.

The source driver 540 illustrated in FIG. 8 generally is one of a plurality of source drivers included in an LCD. An LCD may include eight source drivers, such as the source driver 540, but the total number of source drivers may be changed to be proportional to the size of the LCD panel. Also, each of the source drivers may be capable of driving 480 source lines (or channels), in some embodiments.

In LCD driving circuits according to some embodiments of the present invention, a constant power voltage VDDR and ground voltage VSSR may be applied as bias voltages to the output buffers 542, 544, and 546 included in the source driver 540, thereby equalizing the rising/falling times of signals output from the source driver 540. Accordingly, an image can be displayed evenly on a screen, so that the image quality may be improved.

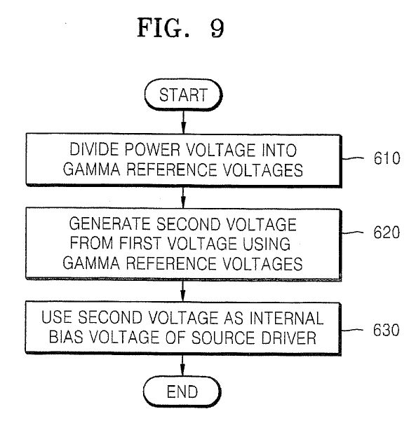

FIG. 9 is a flowchart illustrating operations for driving LCDs according to some embodiments of the present invention.

First, a power voltage is divided into a plurality of gamma reference voltages (Block 610). The gamma reference voltages are generated to be used as reference voltages for regulators.

Next, a second voltage (output voltage) is generated from a first voltage (input voltage) using the generated gamma reference voltages (Block 620). The first voltage may be a power voltage or a ground voltage, and the second voltage is an output voltage that is maintained at a constant level.

Next, the second voltage is used as an internal bias voltage of a source driver (Block 630). In detail, the second voltage is used as a power voltage or a ground voltage of an output buffer included in the source driver.

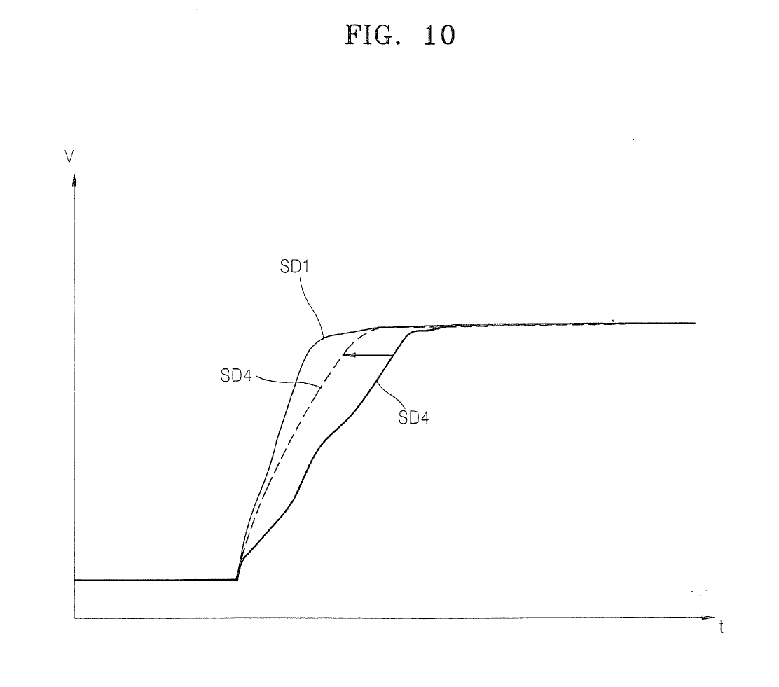

FIG. 10 is a graph illustrating an effect of various embodiment of the present invention. Referring to FIG. 10, the thick solid line denotes an output signal generated when each source driver uses a power/ground voltage applied directly from a power source unit, and the dashed line denotes an output signal generated when each source driver uses an output voltage of a regulator according to some embodiments of the present invention. Here, SD1 denotes a first source driver nearest to the center of an LCD panel, and SD4 denotes a fourth source driver farthest from the center of the LCD panel.

Referring to FIG. 10, the rise time of a signal output from the fourth source driver SD4 when using a regulator according to some embodiments of the present invention, is shorter than when using a conventional technique. That is, the slew offset between signals output from the first source driver SD1 and the fourth source driver SD4 according to some embodiments of the invention is far smaller than when using the conventional technique.

More specifically, referring to FIG. 10, the slew offset between the signals output from the first source driver SD1 and the fourth source driver SD4 is 1.5 μs when using the conventional technique, but the slew offset is reduced to 0.6 μs when using some embodiments of the present invention. In particular, the slew rate is reduced to 0.3 μs when resistance values are adjusted in consideration of the point in time when a power/ground voltage is applied, which varies according to the location of a source driver.

As described above, according to some embodiments of the present invention, it is possible to apply a relatively constant power/ground voltage to a source driver irrespective of the location of the source driver, which can reduce the offset between the rise time and the fall time of a signal output from the source driver. Also, it is possible to reduce or prevent a part of an image from being displayed with a delay on a screen and/or an afterimage from being generated on the screen, which can improve the image quality.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. An LCD (liquid crystal display) comprising:
an LCD panel; and
a driving circuit that is configured to drive the LCD panel, the driving circuit comprising:
a timing controller that is configured to divide a power voltage, which is supplied from a power source unit, into a plurality of gamma reference voltages;
a regulator that is configured to generate a second voltage from a first voltage by using the gamma reference voltages as internal reference voltages, where the first voltage is an input voltage and the second voltage is an output voltage; and
a source driver that is configured to use the second voltage as an internal bias voltage.

2. The LCD of claim 1, wherein the second voltage is adjusted according to a location of the source driver on the LCD panel.

3. The LCD of claim 2, wherein, if the first voltage is a power voltage, the second voltage is increased proportional to a distance between the source driver and a center of the LCD panel.

4. The LCD of claim 2, wherein, if the first voltage is a ground voltage, the second voltage is decreased proportional to a distance between the source driver and a center of the LCD panel.

5. The LCD of claim 2, wherein the second voltage is adjusted by changing a resistance value of at least one resistor included in the regulator.

6. The LCD of claim 1, wherein the gamma reference voltages are categorized into a plurality of groups, and
the regulator is configured to use the gamma reference voltages belonging to one of the groups as the internal reference voltages.

7. The LCD of claim 6, wherein the regulator is configured to use as the internal reference voltages a highest gamma reference voltage and a lowest gamma reference voltage which belong to the group of the gamma reference voltages.

8. The LCD of claim 1, further comprising a gamma buffer that is configured to amplify the gamma reference voltages received from the timing controller, and to output the amplified voltages to the regulator.

9. The LCD of claim 1, wherein at least one of the gamma reference voltages is applied to a first input terminal of a comparing amplifier included in the regulator, and
at least one of the remaining gamma reference voltages is applied to a supply terminal and/or a ground terminal of the regulator.

10. The LCD of claim 1, wherein the gamma reference voltages are generated by gamma resistors included in the timing controller.

11. The LCD of claim 1, wherein the timing controller is configured to generate eight gamma reference voltages from the power voltage.

12. The LCD of claim 1, wherein the source driver comprises eight source drivers and wherein each of the source drivers drives 480 source lines.

13. An LCD (liquid crystal display) comprising:
an LCD panel; and
a driving circuit that is configured to drive the LCD panel, the driving circuit comprising:
a regulator is configured to generate a second voltage from a first voltage by using gamma reference voltages as internal reference voltages, where the first voltage is an input voltage and the second voltage is an output voltage; and
a source driver that is configured to use the second voltage as an internal bias voltage.

14. The LCD of claim 13, wherein the second voltage is adjusted according to a location of the source driver on the LCD panel.

15. The LCD of claim 14, wherein, if the first voltage is a power voltage, the second voltage is increased proportional to a distance between the source driver and a center of the LCD panel, and
if the first voltage is a ground voltage, the second voltage is reduced proportional to the distance between the source driver and the center of the LCD panel.

16. The LCD of claim 13, further comprising a gamma resistor that is configured to divide a power voltage, which is supplied from a power source unit, into the gamma reference voltages.

17. A method of driving a source driver of an LCD (liquid crystal display), the method comprising:
dividing a power voltage, which is supplied from a power source unit, into a plurality of gamma reference voltages;
generating a second voltage from a first voltage by using the gamma reference voltages as internal reference voltages of a regulator, where the first voltage is an input voltage and the second voltage is an output voltage; and
using the second voltage as an internal bias voltage of a source driver.

18. The method of claim 17, wherein the generating of the second voltage comprises adjusting the second voltage according to a location of the source driver on the LCD.

19. The method of claim 18, wherein, if the first voltage is a power voltage, the generating of the second voltage comprises increasing the second voltage proportional to a distance between the source driver and a center of the LCD panel.

20. The method of claim 18, wherein, if the first voltage is a ground voltage, the generating of the second voltage comprises decreasing the second voltage proportional to a distance between the source driver and a center of the LCD.

21. The method of claim 18, wherein the generating of the second voltage comprises adjusting the second voltage by adjusting a resistance value of at least one resistor included in the regulator.

22. The method of claim 17, wherein the generating of the second voltage comprises:
categorizing the generated gamma reference voltages into a plurality of groups according to their voltage levels; and
using, as the internal reference voltages, gamma reference voltages belonging to a group selected from among the groups of the gamma reference voltages.

23. The method of claim 22, wherein the generating of the second voltage comprises using, as the internal reference voltages, a highest gamma reference voltage and a lowest gamma reference voltage selected from among the gamma reference voltages belonging to the selected group.

24. The method of claim 17, further comprising receiving and amplifying the gamma reference voltages, and outputting the amplified voltages to the regulator.

25. The method of claim 17, wherein the generating of the second voltage comprises generating the second voltage by receiving at least one of the gamma reference voltages via a first input terminal of a comparing amplifier included in the regulator and by receiving at least one of the remaining gamma reference voltages via a supply terminal or a ground terminal of the regulator.

26. A method of driving a source driver of an LCD (liquid crystal display), the method comprising:
generating a second voltage from a first voltage by using gamma reference voltages as internal reference voltages of a regulator, where the first voltage is an input voltage and the second voltage is an output voltage; and
using the second voltage as an internal bias voltage of a source driver.

27. A method of driving a source driver of an LCD (liquid crystal display), the method comprising:
using gamma reference voltages as internal reference voltages of a regulator;
adjusting a resistance value of a resistor included in the regulator according to a location of a source driver;
generating a second voltage from a first voltage applied to the regulator; and
using the second voltage as an internal bias voltage of the source driver.

28. An LCD (liquid crystal display) comprising:
an LCD panel;
a plurality of source drivers that are distributed at different locations on the LCD panel and are supplied with a power voltage by a common power line that extends from external of the LCD panel to the plurality of source drivers; and
a compensating system that is configured to provide different bias voltages to at least two of the source drivers based on their different locations on the LCD panel so as to at least partially compensate for differences in the power voltage that is supplied to the source drivers by the common power line as a result of their different locations on the LCD panel.

29. The LCD of claim 28 wherein the compensating system is configured to increase the bias voltage that is applied to a given source driver proportional to its distance from a section of the common power line that extends external of the LCD panel.

30. A method of operating an LCD (liquid crystal display) that includes an LCD panel and a plurality of source drivers that are distributed at different locations on the LCD panel and are supplied with a power voltage by a common power line that extends from external of the LCD panel to the plurality of source drivers, the method comprising:
providing different bias voltages to at least two of the source drivers based on their different locations on the LCD panel so as to at least partially compensate for differences in the power voltage that is supplied to the source drivers by the common power line as a result of their different locations on the LCD panel.

31. The method of claim 30 wherein providing different bias voltages comprises increasing the bias voltage that is applied to a given source driver proportional to its distance from a section of the common power line that extends external of the LCD panel.

32. An LCD (liquid crystal display) comprising:
an LCD panel;
a plurality of source drivers that are distributed at different locations on the LCD panel and are supplied with a power voltage by a common power line that extends from external of the LCD panel to the plurality of source drivers; and
means for providing different bias voltages to at least two of the source drivers based on their different locations on the LCD panel so as to at least partially compensate for differences in the power voltage that is supplied to the source drivers by the common power line as a result of their different locations on the LCD panel.

33. The LCD of claim 32 wherein the means for providing different bias voltages comprises means for increasing the bias voltage that is applied to a given source driver proportional to its distance from a section of the common power line that extends external of the LCD panel.
